(19) United States
(12) Patent Application Publication
(10) Pub. No.: US 2023/0273542 A1
(43) Pub. Date: Aug. 31, 2023

(54) TONER SET, IMAGE FORMING METHOD, AND IMAGE FORMING APPARATUS

(71) Applicant: CANON KABUSHIKI KAISHA, Tokyo (JP)

(72) Inventors: DAI NOZAKI, Shizuoka (JP); MASATAKE TANAKA, Kanagawa (JP); TAIJI KATSURA, Shizuoka (JP); SHINTARO KAWAGUCHI, Kanagawa (JP)

(21) Appl. No.: 18/175,317

(22) Filed: Feb. 27, 2023

(30) Foreign Application Priority Data
Feb. 28, 2022 (JP) 2022-028819

(51) Int. Cl. G03G 9/097; G03G 9/08; G03G 15/08

(52) U.S. Cl. CPC G03G 9/09725; G03G 9/0819; G03G 9/09775; G03G 15/08

(57) ABSTRACT

A toner set capable of eliminating unclearness in a color boundary of an image in which a color image and a black image are printed side by side. The toner set includes at least: a black toner for forming a black image; and a color toner for forming a color toner image. The black toner is a toner comprising a black toner particle containing a black colorant formed of carbon black or iron oxide, a binder resin, and a releasing agent, and an external additive. The color toner is a toner comprising a color toner particle containing a color organic colorant, a binder resin, and a releasing agent. A ratio in surface roughness (Sa) between the toners is 1.30≤ surface roughness Sa(C) of color toner/surface roughness Sa(Bk) of black toner ≤4.00. The surface roughness Sa(C) of the color toner is 10 nm to 30 nm.

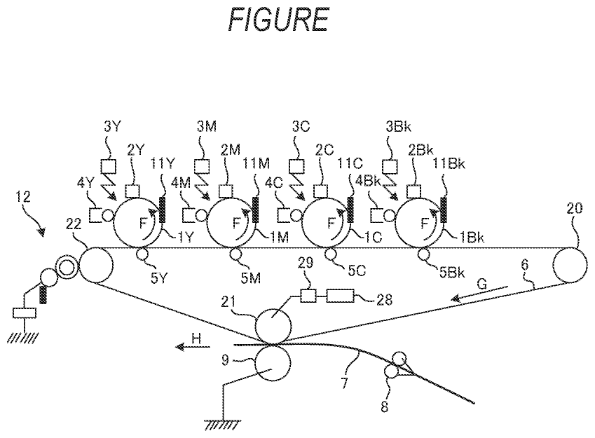

### BACKGROUND OF THE INVENTION

### Field of the Invention

The present disclosure relates to a toner set for electrostatic development to be used in a recording method utilizing an electrophotographic method or the like, an image forming apparatus, and an image forming method.

### Description of the Related Art

In recent years, there has been an increasing diversification of the intended use and usage environment of an image forming apparatus, such as a copying machine or a printer. In addition, a further increase in speed of the image forming apparatus, a further improvement in image quality thereof, and a further improvement in stability thereof have been required. Further, in recent years, the colorization of such apparatus has rapidly advanced. Along with this, the demand for high image quality and high stability has been further increasing.

An electrophotographic method includes: a charging step of charging an electrostatic latent image-bearing member (hereinafter referred to as photosensitive member) by a charging unit; an exposing step of exposing the charged photosensitive member to form an electrostatic latent image; and a developing step of developing the electrostatic latent image with a toner to form a toner image. Then, the toner image is subjected to: a transfer step of transferring the toner image onto a recording material (transfer material) through or without through an intermediate transfer body; and a fixing step of passing the recording material carrying the toner image through a nip portion formed of a pressurizing member and a rotatable image-heating member to fix the toner image with heat and pressure. Thus, an image is output.

In order to meet the recent demand for high image quality and high stability of a color printer, it is important to clearly express the respective colors of an output image without blurring, and it is particularly important to clearly express black without color unevenness. To that end, it is required to accurately draw a latent image drawn on the photosensitive member with the toner, accurately transfer the image onto the intermediate transfer body and the recording material, and fix the image, and it is required that the fixed image remain unchanged even after performing printing on a number of sheets. However, in those processes, it is difficult to cause the toner to remain on an intended printing position, leading to unclearness of a printed image. In each process, the toner is moved by an electrostatic force and held. In addition, a physical force by conveyance acts. In order to move the toner to a position as targeted to remain the toner at the place under such circumstances, chargeability of the toner is important, and it is important to generate an electrostatic adhesive force in accordance therewith.

Carbon black and iron oxide, which are colorants generally used in a black toner, have relatively low electrical resistance, and hence the chargeability of the black toner also tends to be low. Accordingly, a difference in charge quantity occurs between the black toner and a color toner, and an image failure is liable to occur in accordance therewith. In particular, when solid images or halftone images (HT images) of a color image and a black image are printed side by side, there is a disadvantage in that blurring occurs in a boundary or a hazed image unevenness (mottle) of the black image is emphasized.

In view of this, in Japanese Patent Application Laid-Open No. 2018-054704, Japanese Patent Application Laid-Open No. 2021-071612, or Japanese Patent Application Laid-Open No. 2003-107796, in order to fill the difference in charge quantity between the black toner and the color toner, there have heretofore been proposed a technology of controlling the kind and amount of a releasing agent to be exposed on a surface of each toner to adjust aggregation and liberation of an external additive and a method of increasing an amount of the external additive in the color toner as compared to that in the black toner (Japanese Patent Application Laid-Open No. 2018-054704, Japanese Patent Application Laid-Open No. 2021-071612, and Japanese Patent Application Laid-Open No. 2003-107796).

However, when the releasing agent is exposed on the surface of each toner as in Japanese Patent Application Laid-Open No. 2018-054704 and Japanese Patent Application Laid-Open No. 2021-071612, fluctuation is large particularly in a high-temperature environment, and stability is insufficient in long-term use. In addition, the chargeability of the black toner cannot be improved only by increasing the amount of the external additive in the color toner as in Japanese Patent Application Laid-Open No. 2003-107796, and hence the image unevenness of the black image is still susceptible to improvement.

### SUMMARY OF THE INVENTION

The present disclosure provides a toner set, an image forming apparatus, and an image forming method that have solved the above-mentioned disadvantage. Specifically, the present disclosure provides a toner set, an image forming apparatus, and an image forming method each of which is capable of reducing a difference in charge quantity between a black toner and a color toner, eliminating unclearness in a color boundary of an image in which a color image and a black image are printed side by side, and reducing an emphasized image unevenness of the black image.

The inventors of the present disclosure have repeatedly made extensive investigations, and as a result, have found that the above-mentioned disadvantage can be solved by the toner described below.

That is, the present disclosure relates to a toner set comprising at least: a black toner for forming a black image; and a color toner for forming a color toner image, wherein the black toner is a toner comprising a toner particle containing a black colorant formed of carbon black or iron oxide, a binder resin, and a releasing agent, and an external additive, wherein the color toner is a toner comprising a color toner particle comprising a color organic colorant, a binder resin, and a releasing agent, wherein a ratio in surface roughness (Sa) between the toners is 1.30≤ surface roughness Sa(C) of color toner/surface roughness Sa(Bk) of black toner ≤4.00, and wherein the surface roughness Sa(C) of the color toner is 10 to and 30.

The present disclosure also relates to an image forming apparatus comprising: a first image forming station; a second image forming station; an intermediate transfer body; a secondary transfer unit configured to secondarily transfer a synthesized toner image from a surface of the intermediate transfer body onto a surface of a transfer material; and a fixing unit configured to fix the synthesized toner image to the surface of the transfer material, the first image forming station comprising: a first electrophotographic photosensitive member; a charging device configured to charge a surface of the first electrophotographic photosensitive member; an image exposing device configured to irradiate the surface of the first electrophotographic photosensitive member with image exposure light to form a first electrostatic image; a developing device which includes a black toner and is configured to develop the first electrostatic image by the black toner to form a black toner image on the surface of the first electrophotographic photosensitive member; and a primary transferring device configured to primarily transfer the black toner image from the surface of the first electrophotographic photosensitive member onto the surface of the intermediate transfer body, the second image forming station comprising: a second electrophotographic photosensitive member; a charging device configured to charge a surface of the second electrophotographic photosensitive member; an image exposing device configured to irradiate the surface of the second electrophotographic photosensitive member with image exposure light to form a second electrostatic image; a developing device which includes a color toner and is configured to develop the second electrostatic image by the color toner to form a color toner image on the surface of the second electrophotographic photosensitive member; and a primary transferring device configured to primarily transfer the color toner image from the surface of the second electrophotographic photosensitive member onto the surface of the intermediate transfer body, wherein the synthesized toner image is formed by the primary transfer of the black toner image and the color toner image onto the surface of the intermediate transfer body, and wherein the black toner having the above-mentioned configuration is used as the black toner and the color toner having the above-mentioned configuration is used as the color toner.

The present disclosure also relates to an image forming method comprising: a first image forming step; a second image forming step; a secondary transfer step of secondarily transferring a synthesized toner image from a surface of an intermediate transfer body onto a surface of a transfer material; and a fixing step of fixing the synthesized toner image to the surface of the transfer material, the first image forming step comprising: a charging step of charging a surface of a first electrophotographic photosensitive member; an image exposing step of irradiating the surface of the first electrophotographic photosensitive member with image exposure light to form a first electrostatic image; a developing step of developing the first electrostatic image by a black toner to form a black toner image on the surface of the first electrophotographic photosensitive member; and a primary transfer step of primarily transferring the black toner image from the surface of the first electrophotographic photosensitive member onto the surface of the intermediate transfer body, the second image forming step comprising: a charging step of charging a surface of a second electrophotographic photosensitive member; an image exposing step of irradiating the surface of the second electrophotographic photosensitive member with image exposure light to form a second electrostatic image; a developing step of developing the second electrostatic image by a color toner to form a color toner image on the surface of the second electrophotographic photosensitive member; and a primary transfer step of primarily transferring the color toner image from the surface of the second electrophotographic photosensitive member onto the surface of the intermediate transfer body, wherein the synthesized toner image is formed by the primary transfer of the black toner image and the color toner image onto the surface of the intermediate transfer body, and wherein the black toner having the above-mentioned configuration is used as the black toner and the color toner having the above-mentioned configuration is used as the color toner.

Further features of the present disclosure will become apparent from the following description of exemplary embodiments with reference to the attached drawing.

### BRIEF DESCRIPTION OF THE DRAWINGS

FIGURE is an explanatory view of an image forming apparatus comprising electrophotographic stations of a plurality of colors arranged thereon.

### DESCRIPTION OF THE EMBODIMENTS

[Features of the Present Disclosure]

The present disclosure is described in detail below, but is not limited to the following embodiments.

In order to improve unclearness in a color boundary and an image unevenness of a black image in a printing method comprising using at least a color toner and a black toner, the inventors of the present disclosure have made extensive investigations for keeping chargeability of the black toner equivalent to that of the color toner.

A toner of the present disclosure contains widely-used carbon black or iron oxide as a colorant of a black toner and an organic colorant as a colorant of a color toner. Carbon black or iron oxide has relatively small electrical resistance, and charge is liable to leak. Accordingly, the black toner has low chargeability as compared to the color toner, and a difference in charge quantity occurs therebetween. The difference in charge quantity causes imbalance of a balance of an electric field when the toners are arranged side by side on an intermediate transfer belt, and each toner cannot remain on the first printed position because an unnecessary force acts thereon. In addition, also at the time of secondary transfer from the transfer belt onto a medium, a force acts in a different way to cause a shift on a move position, resulting in unclearness in the color boundary. In addition, the black toner has a low charge quantity, and hence an electrostatic adhesive force also becomes low. A physical force, such as vibration or air resistance, at the time of conveyance in a printing process results in shifting the position of the black toner having a weak adhesive force with a medium, and the shift results in an image unevenness. In particular, the unevenness of the black image is liable to become conspicuous when arranged side by side with a color image, and hence it is a disadvantage for high image quality printing.

In view of this, the inventors of the present disclosure have found that the difference in charge quantity between the color toner and the black toner is eliminated and an image failure is improved by heightening a protrusion shape of a surface of the color toner, in other words, increasing a surface roughness Sa(C) thereof, and lowering a protrusion shape of a surface of the black toner as compared to that of the color toner, in other words, reducing a surface roughness Sa(Bk) thereof, to thereby complete the present disclosure.

Specifically, the present disclosure relates to a toner set comprising at least: a black toner for forming a black image; and a color toner for forming a color toner image, wherein the black toner is a toner comprising a toner particle containing a black colorant formed of carbon black or iron oxide, a binder resin, and a releasing agent, and an external additive, wherein the color toner is a toner comprising a color organic colorant, a binder resin, and a releasing agent, wherein a ratio in surface roughness (Sa) between the toners is 1.30≤ surface roughness Sa(C) of color toner/surface roughness Sa(Bk) of black toner ≤4.00, and wherein the surface roughness Sa(C) of the color toner is 10 nm to 30 nm.

Now, the present disclosure is described in more detail.

The black toner containing carbon black or iron oxide as a colorant is liable to cause charge leakage, and hence a difference in charge quantity is liable to occur between the black toner and the color toner. In the present disclosure, it has been found that when the surface roughness Sa(C) of the color toner is set to 10 nm to 30 nm, and the ratio in surface roughness (Sa) between the toners is set to 1.30≤ surface roughness Sa(C) of color toner/surface roughness Sa(Bk) of black toner ≤4.00, a charge quantity of the black toner becomes equivalent to that of the color toner over long-term continuous printing, and unclearness in a color boundary and an image unevenness of a black image can be suppressed. The inventors of the present disclosure have conceived the reason for the foregoing to be as described below.

In order to stably keep the charge quantity over long-term continuous printing, it is preferred that a protrusion shape of a surface be high, in other words, the surface roughness be high. The protrusion shape of the surface of the toner may be formed by sticking inorganic fine powder typified by silica having a size of about 100 nm or an organic fine powder external additive such as an organosilicon polymer particle to the surface of the toner, or may be formed by a surface layer having a protrusion shape formed of an organosilicon polymer on a surface thereof. For long-term stability, the surface roughness derived from the protrusion shape of the surface is preferably larger. However, larger magnitude of the surface roughness makes the toner difficult to roll because a hook is formed on the surface of the toner, and hence acts so that the efficiency of triboelectric charging deteriorates. When the protrusion shape of the surface or the surface roughness is low, the toner easily rolls, and hence the efficiency of the triboelectric charging improves to increase the charge quantity. In other words, according to the present disclosure, when the surface roughness of the black toner which is liable to cause the charge leakage is set to be lower than that of the color toner, an increase in charge quantity by improvement in the efficiency of the triboelectric charging offsets the charge leakage, and hence charge quantities of the black toner and the color toner can be designed to be about equivalent to each other. When the charge quantities become comparable, the balance of the electric field becomes constant when the toners are arranged side by side on the intermediate transfer belt, and the unnecessary force is prevented from acting. As a result, each toner can remain on the first printed position.

In addition, also at the time of the secondary transfer from the transfer belt onto a medium, a force acting on each toner is stabilized, and hence a clear color boundary can be formed by accurately transferring the toners. In addition, in accordance with increase in charge quantity of the black toner, the electrostatic adhesive force also becomes high, and hence the toner obtains a resistance force to a physical force, such as vibration or air resistance, to which the toner is subjected at the time of conveyance in the printing process. Accordingly, a position of the black toner is prevented from shifting on the medium, and hence the image unevenness is reduced. In general, the charge quantity is adjusted by a formulation of a toner particle such as a charge control agent. However, when there is no chance of friction, the charging also cannot be performed, and hence it is insufficient to have only the internal formulation of the toner particle, and thus the effect of the present disclosure is required.

The surface roughness derived from a protrusion height of the surface shown in the present disclosure is measured using a scanning probe microscope (SPM). A toner is uniformly placed on and fixed to a sample stage using an electroconductive double-sided tape, and a charge of the surface of the toner is removed with a charge eliminating device. After that, the surface of the toner is measured with the SPM. In the SPM measurement, SI-DF20 manufactured by Seiko Instruments Inc. (back surface: Al coat) is used as a cantilever and measurement is performed in a dynamic force mode. A range of 1 μm×1 μm in a surface of one particle of the toner is subjected to measurement, and the measurement is performed on 50 particles. The obtained SPM images are observed, and at least 30 or more results are analyzed while an image having an obvious defect is removed. The obtained each image is subjected to surface roughness analysis, and a surface roughness Sa of a 1 μm×1 μm surface is calculated. An average value of Sa of all the analyzed images was defined as a value of the surface roughness of the toner. In addition, when the measurement result is abnormal owing to contamination or degradation of the cantilever, a maximum protrusion height Sp tends to increase, and hence an image having an Sp serving as the maximum protrusion height of 150 nm or more is removed at the time of the analysis, and is not included in the images for calculating the Sa.

[Control of Surface Roughness of Toner]

In the present disclosure, control of the surface roughness of the toner can be achieved by externally adding various organic or inorganic fine powders to a toner particle. The surface roughness can be controlled by the kind and amount of the organic or inorganic fine powder, or, when a surface layer formed of an organosilicon polymer to be described below is present, by a production method therefor and the number of parts thereof to be loaded.

The organic or inorganic fine powder to be externally added is not particularly limited, and known powder may be used. For example, the following powders may each be used.
(1) Flowability-imparting agent: silica, alumina, titanium oxide, carbon black, and carbon fluoride.
(2) Polishing agent: metal oxides (e.g., strontium titanate, cerium oxide, alumina, magnesium oxide, and chromium oxide), nitrides (e.g., silicon nitride), carbides (e.g., silicon carbide), and metal salts (e.g., calcium sulfate, barium sulfate, and calcium carbonate).
(3) Lubricant: fluorine-based resin powders (e.g., vinylidene fluoride and polytetrafluoroethylene), and fatty acid metal salts (e.g., zinc stearate and calcium stearate).
(4) Charge-controlling particles: metal oxides (e.g., tin oxide, titanium oxide, zinc oxide, silica, and alumina), and hydrotalcite.

As a color toner which forms a protrusion corresponding to the roughness of the surface of the toner, it is preferred that the organosilicon polymer be used in the color toner and the color toner contain the organosilicon polymer on a surface of the toner particle in order to keep the difference in surface roughness between the color toner and the black toner throughout the endurance by continuous use. The organosilicon polymer may be externally added as a particle, or, as a more preferred form, may be present on the surface of the toner particle as a surface layer having a protrusion shape. In addition, the organosilicon polymer particle, the organosilicon polymer surface layer, and the inorganic fine powder may also be used in combination.

The organosilicon polymer has a feature of having elasticity as compared to the inorganic fine powder such as silica that is generally externally added to a toner particle. With this elasticity, the organosilicon polymer allows a force from the outside to escape, and can avoid being embedded in the surface of the toner and being changed over long-term use. Accordingly, the color toner can keep the difference in surface roughness between the color toner and the black toner.

A method of producing the organosilicon polymer particle is not particularly limited, and an example thereof may be as follows: a silane compound is dropped into water, and is subjected to hydrolysis and condensation reactions with a catalyst; and the obtained suspension is filtered and dried. The particle diameter of the organosilicon polymer particle may be controlled by the kind of the catalyst, the blending ratio thereof, a reaction start temperature, a dropping time, and the like.

Examples of the catalyst include, but not limited to: acidic catalysts, such as hydrochloric acid, hydrofluoric acid, sulfuric acid, and nitric acid; and basic catalysts, such as ammonia water, sodium hydroxide, and potassium hydroxide.

The organosilicon polymer particle is obtained from a silane compound having a unit selected from the group consisting of units represented by the following formula (1), formula (2), formula (3), and formula (4).

As a compound having a unit structure represented by the formula (1), there are given, for example, tetramethoxysilane and tetraethoxysilane. The compound is not particularly limited as long as the compound has the unit structure of the formula (1).

As a compound having a unit structure represented by the formula (2), there are given, for example, methyltrimethoxysilane, ethyltrimethoxysilane, propyltrimethoxysilane, butyltrimethoxysilane, pentyltrimethoxysilane, methyltriethoxysilane, ethyltriethoxysilane, and methyltrichlorosilane. The compound is not particularly limited as long as the compound has the unit structure of the formula (2).

As a compound having a unit structure represented by the formula (3), there are given, for example, dimethyldimethoxysilane, dimethyldiethoxysilane, diethyldimethoxysilane, dipropylmethoxysilane, and dibutylmethoxysilane. The compound is not particularly limited as long as the compound has the unit structure of the formula (3).

As a compound having a unit structure represented by the formula (4), there are given, for example, trimethylmethoxysilane, trimethylethoxysilane, triethylmethoxysilane, triethylethoxysilane, tripropylmethoxysilane, tributylmethoxysilane, tripentylmethoxysilane, and trimethylchlorosilane. The compound is not particularly limited as long as the compound has the unit structure of the formula (4).

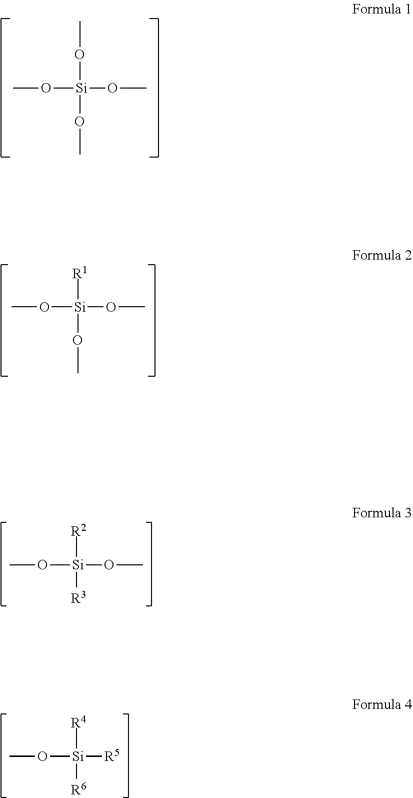

where R¹ to R⁶ each independently represent an alkyl group having 1 to 6 carbon atoms, a phenyl group, a halogen atom, a hydroxy group, an acetoxy group, or an alkoxy group having 1 to 6 carbon atoms, and at least one of R⁴, R⁵, and R⁶ represents an alkyl group having 1 to 6 carbon atoms.

In the present disclosure, a polysilsesquioxane fine particle formed only of the compound having the unit structure represented by the formula (2) is particularly preferred from the viewpoint of maintenance of durability.

A method of producing the organosilicon polymer surface layer having a protrusion shape is also not particularly limited, and as a preferred method of forming a protrusion shape on a surface of the toner particle, it is preferred that a toner base particle be dispersed in an aqueous medium to provide a toner base particle-dispersed liquid, and then an organosilicon compound be added thereto to form the protrusion shape, to thereby provide a toner particle-dispersed liquid.

A solid content concentration in the toner base particle-dispersed liquid is preferably adjusted to 25 mass % to 50 mass %. In addition, a temperature of the toner base particle-dispersed liquid is preferably adjusted to 35° C. or more. In addition, a pH of the toner base particle-dispersed liquid is preferably adjusted to the pH at which the condensation of the organosilicon compound hardly advances. The pH at which the condensation of the organosilicon polymer hardly advances varies depending on the substance, and hence the pH preferably falls within the range of the pH at which the reaction most hardly advances serving as a center plus and minus 0.5.

Meanwhile, the organosilicon compound is preferably used after having been subjected to hydrolysis treatment. For example, as pretreatment, the organosilicon compound is subjected to hydrolysis in another vessel. With regard to a loading concentration in the hydrolysis, when the amount of the organosilicon compound is set to 100 parts by mass, the amount of water from which an ionic content has been removed, such as ion-exchanged water or RO water, is preferably 40 parts by mass or more and 500 parts by mass or less, and the amount of water is more preferably 100 parts by mass or more and 400 parts by mass or less. The hydrolysis is preferably performed under the conditions of a pH of from 2 to 7, a temperature of from 15° C. to 80° C., and a time period of from 30 minutes to 600 minutes.

The obtained hydrolyzed liquid and the toner particle-dispersed liquid are mixed, and the pH of the mixture is adjusted to a pH suitable for the condensation (preferably a pH of from 6 to 12 or from 1 to 3, more preferably from 8 to 12). The protrusion shape can be easily formed by adjusting the amount of the hydrolyzed liquid so that the amount of the organosilicon compound is 5.0 parts by mass or more and 30.0 parts by mass or less with respect to 100 parts by mass of the toner particle. The formation of the protrusion shape and the condensation are preferably performed by holding a temperature and a time at 35° C. or more and 60 minutes or more.

In addition, when the protrusion shape of the surface of the toner particle is controlled, the pH is preferably adjusted in two stages. When a holding time before the adjustment of the pH and a holding time before the adjustment of the pH in the second stage are appropriately adjusted to condensate the organosilicon compound, the protrusion shape of the surface of the toner particle can be controlled. In addition, the protrusion shape can be controlled also by adjustment of the condensation temperature of an organic compound within the range of 35° C. to 80° C.

The organosilicon polymer surface layer of the present disclosure is obtained from a silane compound having a unit selected from the group consisting of units represented by the above-mentioned formula (1), formula (2), formula (3), and formula (4). Of those, an organosilicon polymer surface layer having a unit structure represented by the formula (2) is particularly preferred from the viewpoint of durability. It is more preferred that in ²⁹Si-NMR with respect to a THF-insoluble content of the toner, the ratio of an area of a peak (T3) derived from a structure in which all of the three oxygen atoms in the unit of the formula (2) are bonded to Si to an area of a total Si peak be 0.50 to 1.00. The amount of a T3 unit structure is important for controlling the elasticity of the organosilicon polymer, and the above-mentioned content is optimum for suppressing a change in surface roughness of the color toner over long-term continuous use, and hence keeping the difference between the color toner and the black toner.

The surface roughness Sa(Bk) of the black toner is suitably 5 nm or more and less than 15 nm. This range is optimum for reducing a scram effect and improving the efficiency of the triboelectric charging. Further, it is more preferred that the range of the surface roughness Sa(C) of the color toner be 15 nm to 25 nm and the range of the surface roughness Sa(Bk) of the black toner be 5 nm 10 nm.

[Toner Configuration]

Now, constituent components of the toners (the black toner and the color toner) included in the toner set according to this embodiment are described.

[Binder Resin]

The toner of the present disclosure contains the binder resin. The binder resin is not particularly limited, and a conventionally known resin may be used. Preferred examples of the binder resin may include a vinyl-based resin and a polyester resin. Examples of the vinyl-based resin, the polyester resin, and any other binder resin may include the following resins or polymers:

homopolymers of styrene and substituted products thereof, such as polystyrene and polyvinyltoluene; styrene-based copolymers, such as a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-dimethylaminoethyl acrylate copolymer, a styrene-methyl methacrylate copolymer, a styrene-ethyl methacrylate copolymer, a styrene-butyl methacrylate copolymer, a styrene-dimethylaminoethyl methacrylate copolymer, a styrene-vinyl methyl ether copolymer, a styrene-vinyl ethyl ether copolymer, a styrene-vinyl methyl ketone copolymer, a styrene-butadiene copolymer, a styrene-isoprene copolymer, a styrene-maleic acid copolymer, and a styrene-maleic acid ester copolymer; and polymethyl methacrylate, polybutyl methacrylate, polyvinyl acetate, polyethylene, polypropylene, polyvinyl butyral, a silicone resin, a polyamide resin, an epoxy resin, a polyacrylic resin, a rosin, a modified rosin, a terpene resin, a phenol resin, an aliphatic or alicyclic hydrocarbon resin, and an aromatic petroleum resin. Those binder resins may be used alone or as a mixture thereof.

In the present disclosure, the polyester resin is preferably present on the surface of the toner particle, and its molecular weight Mw is preferably 5,000 to 30,000. When the polyester resin is present on the surface, the protrusion shape of the surface of the toner is hardly embedded in the surface, which is advantageous for keeping the difference between the color toner and the black toner over long-term continuous use.

Polyester resins obtained by subjecting the following carboxylic acid components and alcohol components to polycondensation may each be used as the polyester resin. Examples of the carboxylic acid component include terephthalic acid, isophthalic acid, phthalic acid, fumaric acid, maleic acid, cyclohexanedicarboxylic acid, and, and trimellitic acid. Examples of the alcohol component include bisphenol A, hydrogenated bisphenol, an ethylene oxide adduct of bisphenol A, a propylene oxide adduct of bisphenol A, glycerin, trimethylolpropane, and pentaerythritol.

[Crosslinking Agent]

A crosslinking agent may be added at the time of the polymerization of a polymerizable monomer for controlling the molecular weight of the binder resin for forming the toner particle.

Examples thereof include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinyl benzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate, polyester-type diacrylate (MANDA, Nippon Kayaku Co., Ltd.), and compounds obtained by changing the above-mentioned acrylates to methacrylates.

The addition amount of the crosslinking agent is preferably 0.001 mass % to 15.000 mass % with respect to the polymerizable monomer.

[Releasing Agent]

In the present disclosure, the toner particle contains the releasing agent as one material for forming the toner particle. Examples of the releasing agent that may be used in the toner particle include: a petroleum-based wax, such as a paraffin wax, a microcrystalline wax, or petrolatum, and derivatives thereof; a montan wax and derivatives thereof; a hydrocarbon wax obtained by a Fischer-Tropsch method and derivatives thereof; a polyolefin wax, such as polyethylene or polypropylene, and derivatives thereof; a natural wax, such as a carnauba wax or a candelilla wax, and derivatives thereof; a higher aliphatic alcohol; a fatty acid, such as stearic acid or palmitic acid, or compounds thereof; an acid amide wax; an ester wax; a ketone; hydrogenated castor oil and derivatives thereof; a plant wax; an animal wax; and a silicone resin. The derivatives encompass an oxide, a block copolymer with a vinyl-based monomer, and a graft-modified product. The content of the releasing agent is preferably 5.0 parts by mass or more and 20.0 parts by mass or less with respect to 100.0 parts by mass of the binder resin or the polymerizable monomer.

[Charge Control Agent]

In the present disclosure, the toner particle may contain a charge control agent. A known charge control agent may be used as the charge control agent. In particular, a charge control agent having high charging speed and being capable of stably maintaining a constant charge quantity is preferred. Further, when the toner particle is produced by a direct polymerization method, a charge control agent having a low polymerization-inhibiting property and being substantially free of any solubilized product in an aqueous medium is particularly preferred.

Examples of the charge control agent which controls the toner particle so that the particle may be negatively chargeable include the following agents:

As organometallic compounds and chelate compounds, a monoazo metal compound, an acetylacetone metal compound, and aromatic oxycarboxylic acid-, aromatic dicarboxylic acid-, oxycarboxylic acid-, and dicarboxylic acid-based metallic compounds. Other examples thereof include aromatic oxycarboxylic acids, and aromatic mono- and polycarboxylic acids, and metallic salts, anhydrides, or esters thereof, and phenol derivatives, such as bisphenol. Further, there are given a urea derivative, a salicylic acid-based compound containing a metal, a naphthoic acid-based compound containing a metal, a boron compound, a quaternary ammonium salt, and a calixarene.

Meanwhile, examples of the charge control agent which controls the toner particle so that the particle may be positively chargeable include the following agents:

nigrosine and modified nigrosine compounds with a fatty acid metal salt; a guanidine compound; an imidazole compound; quaternary ammonium salts, such as a tributylbenzylammonium-1-hydroxy-4-naphtosulfonate and tetrabutylammonium tetrafluoroborate, and onium salts which are analogs of the above-mentioned compounds, such as a phosphonium salt, and lake pigments thereof; a triphenylmethane dye and a lake pigment thereof (examples of a lacking agent include phosphotungstic acid, phosphomolybdic acid, phosphotungstic molybdic acid, tannic acid, lauric acid, gallic acid, a ferricyanide, and a ferrocyanide); a metal salt of a higher fatty acid; and a resin-based charge control agent.

Those charge control agents may be used alone or in combination thereof. The addition amount of the charge control agent is preferably 0.01 part by mass or more and 10.00 parts by mass or less with respect to 100.00 parts by mass of the binder resin.

[Production Method]

A known method, such as a pulverization method, a suspension polymerization method, a dissolution suspension method, or an emulsion aggregation method, may be used as a method of producing the toner particle. Of those, a suspension polymerization method is preferred. In the suspension polymerization method, a spherical toner particle is easily obtained, and a toner advantageous for rolling friction in the present disclosure can be obtained. An average circularity of the toner particle preferably falls within the range of 0.950 to 1.000. The toner having an average circularity within the range is advantageous for rolling friction because a difference in a scram effect derived from the difference in the surface roughness between the color toner and the black toner is clearly expressed. In addition, in the suspension polymerization method, the organosilicon polymer is easily uniformly precipitated on the surface of the toner particle, and hence adhesive property between the surface layer and an inner portion of the toner particle becomes excellent, and environment stability, a suppression effect on a charge quantity reversal component, and durable sustainability thereof become satisfactory. The suspension polymerization method is further described below.

In the suspension polymerization method, first, a polymerizable monomer composition in which a polymerizable monomer and a pigment for synthesizing a binder resin are uniformly dissolved or dispersed is prepared by using a disperser, such as a ball mill or an ultrasonic disperser (polymerizable monomer composition preparing step). At this time, a polyfunctional monomer, a chain transfer agent, a wax serving as a releasing agent, a charge control agent, a plasticizer, or the like may be appropriately added as required.

Preferred examples of the polymerizable monomer in the suspension polymerization method may include the following vinyl-based polymerizable monomers: styrene; styrene derivatives, such as α-methylstyrene, β-methylstyrene, o-methylstyrene, m-methyl styrene, p-methyl styrene, 2,4-dimethyl styrene, p-n-butyl styrene, p-tert-butylstyrene, p-n-hexylstyrene, p-n-octylstyrene, p-n-nonylstyrene, p-n-decyl styrene, p-n-dodecyl styrene, p-methoxystyrene, and p-phenyl styrene; acrylic polymerizable monomers, such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers, such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters, such as vinyl acetate, vinyl propionate, vinyl benzoate, vinyl butyrate, vinyl benzoate, and vinyl formate; vinyl ethers, such as vinyl methyl ether, vinyl ethyl ether, and vinyl isobutyl ether; and vinyl methyl ketone, vinyl hexyl ketone, and vinyl isopropyl ketone.

Next, the polymerizable monomer composition is loaded into an aqueous medium prepared in advance, and droplets each formed of the polymerizable monomer composition are formed in a desired core particle size with a stirring machine or disperser having a high shear force (granulating step).

The aqueous medium in the granulating step preferably contains a dispersion stabilizer for controlling the particle diameter of the core particle, sharpening the particle size distribution of the core particles, and suppressing the coalescence of the core particles in a production process. In general, the dispersion stabilizers are roughly classified into a polymer that expresses a repulsive force based on steric hindrance and a hardly water-soluble inorganic compound that achieves dispersion stabilization with an electrostatic repulsive force. The fine particles of the hardly water-soluble inorganic compound are suitably used because the fine particles are dissolved with an acid or an alkali, and hence can be easily removed by being dissolved through washing with an acid or an alkali after the polymerization of the polymerizable monomer composition.

A dispersion stabilizer containing any of magnesium, calcium, barium, zinc, aluminum, and phosphorus is preferably used as a dispersion stabilizer for the hardly water-soluble inorganic compound. It is more preferred that the dispersion stabilizer contain any of magnesium, calcium, aluminum, and phosphorus. Specific examples thereof include the following dispersion stabilizers:

magnesium phosphate, tricalcium phosphate, aluminum phosphate, zinc phosphate, magnesium carbonate, calcium carbonate, magnesium hydroxide, calcium hydroxide, aluminum hydroxide, calcium metasilicate, calcium sulfate, barium sulfate, and hydroxyapatite.

An organic compound, such as polyvinyl alcohol, gelatin, methylcellulose, methylhydroxypropylcellulose, ethylcellulose, carboxymethylcellulose sodium salt, or starch, may be used in combination with the dispersion stabilizer. Any such dispersion stabilizer is preferably used in an amount of 0.01 part by mass or more and 2.00 parts by mass or less with respect to 100 parts by mass of the polymerizable monomer. Further, a surfactant may be used in combination in an amount of 0.001 mass % to 0.1 mass % for reducing the size of any such dispersion stabilizer. Specifically, commercially available nonionic, anionic, or cationic surfactants may be utilized. For example, sodium dodecyl sulfate, sodium tetradecyl sulfate, sodium pentadecyl sulfate, sodium octyl sulfate, sodium oleate, sodium laurate, potassium stearate, and calcium oleate are preferably used.

After the granulating step or while the granulating step is performed, the polymerization of the polymerizable monomer is performed at a temperature generally set to 50° C. to 90° C. to provide a core particle-dispersed liquid (polymerizing step).

In the polymerizing step, the temperature of a treatment liquid has a large impact on fixation performance of the core particle, and hence a stirring operation is generally performed so that a temperature distribution in a vessel may be uniform. When a polymerization initiator is added, the operation may be performed at an arbitrary timing for an arbitrary time period. In addition, a temperature in the vessel may be increased in the latter half of the polymerization reaction for the purpose of obtaining a desired molecular weight distribution. Further, part of the aqueous medium may be evaporated through a distillation operation in the latter half of the reaction or after the completion of the reaction for removing an unreacted polymerizable monomer, a by-product, or the like to the outside of the system. The distillation operation may be performed under normal pressure or reduced pressure.

An oil-soluble initiator is generally used as the polymerization initiator to be used in the suspension polymerization method. Examples thereof include the following oil-soluble initiators:

azo compounds, such as 2,2′-azobisisobutyronitrile, 2,2′-azobis-2,4-dimethylvaleronitrile, 1,1′-azobis(cyclohexane-1-carbonitrile), and 2,2′-azobis-4-methoxy-2,4-dimethylvaleronitrile; and peroxide-based initiators, such as acetylcyclohexylsulfonyl peroxide, diisopropyl peroxycarbonate, decanoyl peroxide, lauroyl peroxide, stearoyl peroxide, propionyl peroxide, acetyl peroxide, tert-butyl peroxy-2-ethyl hexanoate, benzoyl peroxide, tert-butyl peroxyisobutyrate, cyclohexanone peroxide, methyl ethyl ketone peroxide, dicumyl peroxide, tert-butyl hydroperoxide, di-tert-butyl peroxide, tert-butyl peroxypivalate, and cumene hydroperoxide.

In the polymerization initiator, a water-soluble initiator may be used in combination as required, and examples thereof include the following water-soluble initiators:

ammonium persulfate, potassium persulfate, 2,2′-azobis(N,N′-dimethyleneisobutyramidine) hydrochloride, 2,2′-azobis(2-amidinopropane) hydrochloride, azobis(isobutyramidine) hydrochloride, sodium 2,2′-azobisisobutyronitrile sulfonate, ferrous sulfate, and hydrogen peroxide.

Those polymerization initiators may be used alone or in combination thereof, and a chain transfer agent, a polymerization inhibitor, or the like may be further added and used for controlling the polymerization degree of the polymerizable monomer.

After the polymerizing step, the surface layer containing the organosilicon polymer is formed to provide the toner particle-dispersed liquid (surface layer forming step).

With regard to the particle diameter of the toner in the present disclosure, the weight-average particle diameter thereof is preferably 3.0 μm to 10.0 μm the viewpoint of obtaining a high-definition and high-resolution image. The weight-average particle diameter of the toner may be measured by a pore electrical resistance method. The weight-average particle diameter may be measured with, for example, “Coulter Counter Multisizer 3” (manufactured by Beckman Coulter, Inc.). The toner particle-dispersed liquid thus obtained is fed to a filtering step of subjecting the toner particle and the aqueous medium to solid-liquid separation.

The solid-liquid separation for obtaining the toner particle from the resultant toner particle-dispersed liquid may be performed by a general filtration method. After that, washing is preferably further performed by, for example, reslurrying or washing by the application of washing water for removing foreign matter that could not be completely removed from the surface of the toner particle. After sufficient washing has been performed, solid-liquid separation is performed again to provide a toner cake. After that, the cake is dried by a known drying method, and as required, the group of particles having particle diameters deviating from a predetermined value is separated by classification. Thus, the toner particle is obtained. At this time, the separated group of particles having particle diameters deviating from the predetermined value may be reused for improving the final yield.

[Image Forming Apparatus and Image Forming Method]

An image forming apparatus and an image forming method according to the present disclosure are described below.

The image forming method basically includes: a charging step of charging an image-bearing member using a charging device that is brought into contact with an electrophotographic photosensitive member (image-bearing member); an electrostatic latent image forming step of forming an electrostatic latent image on the image-bearing member; a developing step of developing the electrostatic latent image with a toner to form a toner image; a transfer step of transferring the toner image onto a recording medium (transfer material) through an intermediate transfer body; and a step of fixing by heating the toner image transferred onto the recording medium.

When a synthesized toner image (full-color image) is formed with the above-mentioned black toner and color toner, the image forming method includes: a first image forming step for black; a second image forming step for color; a secondary transfer step of secondarily transferring a synthesized toner image from a surface of an intermediate transfer body onto a surface of a transfer material; and a fixing step of fixing the synthesized toner image to the surface of the transfer material, the first image forming step comprising: a charging step of charging a surface of a first electrophotographic photosensitive member; an image exposing step of irradiating the surface of the first electrophotographic photosensitive member with image exposure light to form a first electrostatic image; a developing step of developing the first electrostatic image by a black toner to form a black toner image on the surface of the first electrophotographic photosensitive member; and a primary transfer step of primarily transferring the black toner image from the surface of the first electrophotographic photosensitive member onto the surface of the intermediate transfer body, the second image forming station comprising: a charging step of charging a surface of a second electrophotographic photosensitive member; an image exposing step of irradiating the surface of the second electrophotographic photosensitive member with image exposure light to form a second electrostatic image; a developing step of developing the second electrostatic image by a color toner to form a color toner image on the surface of the second electrophotographic photosensitive member; and a primary transfer step of primarily transferring the color toner image from the surface of the second electrophotographic photosensitive member onto the surface of the intermediate transfer body, wherein the synthesized toner image is formed by the primary transfer of the black toner image and the color toner image onto the surface of the intermediate transfer body.

More specifically, as illustrated in FIGURE, an image forming apparatus having a so-called tandem-type structure in which image forming stations of a plurality of colors are arranged side by side in a rotating direction of the intermediate transfer belt is suitably used. In the following description, the reference symbols of the structures for respective colors of yellow, magenta, cyan, and black have suffixes Y, M, C, and Bk, respectively, but the suffixes may be omitted for the same structure.

In FIGURE, charging devices 2Y, 2M, 2C, and 2Bk, image exposing devices 3Y, 3M, 3C, and 3Bk, developing devices 4Y, 4M, 4C, and 4Bk, and an intermediate transfer belt (intermediate transfer body) 6 are arranged on the periphery of photosensitive drums (image-bearing members) 1Y, 1M, 1C, and 1Bk. The photosensitive drum 1 is driven to rotate at a predetermined peripheral speed (process speed) in a direction of the arrow F. The charging device 2 charges the peripheral surface of the photosensitive drum 1 to a predetermined polarity and predetermined potential (primary charging). A laser beam scanner serving as the image exposing device 3 outputs laser light that has been on/off-modulated in response to image information input from an external device, such as an image scanner or a computer (not shown), to subject a charging treatment surface on the photosensitive drum 1 to scanning exposure. Through the scanning exposure, an electrostatic latent image corresponding to target image information is formed on the surface of the photosensitive drum 1.

The developing devices 4Y, 4M, 4C, and 4Bk accommodate toners of respective color components of yellow (Y), magenta (M), cyan (C), and black (Bk), respectively. Then, the developing device 4 to be used is selected based on the image information, and a developer (toner) is developed on the surface of the photosensitive drum 1, with the result that the electrostatic latent image is visualized as a toner image. In this embodiment, as described above, there is used a reversal development system involving causing the toner to adhere to an exposed portion of the electrostatic latent image to develop the toner. In addition, the charging device, the exposing device, and the developing device form an electrophotographic unit.

In addition, the intermediate transfer belt 6 is an endless belt, and is arranged so as to be brought into abutment with the surface of the photosensitive drum 1 and tensioned on a plurality of tension rollers 20, 21, and 22. Then, the intermediate transfer belt 6 rotates in a direction of the arrow G. In this embodiment, the tension roller 20 is a tension roller that controls the tension of the intermediate transfer belt 6 to be constant, the tension roller 22 is a drive roller for the intermediate transfer belt 6, and the tension roller 21 is a secondary transfer opposing roller. In addition, primary transfer rollers 5Y, 5M, 5C, and 5Bk are arranged at primary transfer positions opposite to the respective photosensitive drums 1 with the intermediate transfer belt 6 interposed therebetween.

Unfixed toner images of respective colors formed on the respective photosensitive drums 1 are primarily transferred onto the intermediate transfer belt 6 sequentially and electrostatically by applying a primary transfer bias having a polarity opposite to the charging polarity of the toner to each primary transfer roller 5 by a constant voltage source or a constant current source. Then, a full-color image (synthesized toner image) in which the unfixed toner images of four colors are superimposed on the intermediate transfer belt 6 is obtained. The intermediate transfer belt 6 rotates while carrying the toner image transferred from the photosensitive drum 1 as described above. After each rotation of the photosensitive drum 1 from the primary transfer, the surface of the photosensitive drum 1 is cleaned by a cleaning device 11 (11Y, 11M, 11C, or 11Bk) to remove a transfer residual toner, and the image forming process is repeated.

In addition, at a secondary transfer position of the intermediate transfer belt 6 facing a conveyance path of a transfer material 7, a secondary transfer roller (transfer portion) 9 is arranged in pressure contact with the intermediate transfer belt 6 on a toner image carrying surface side. In addition, on a back surface side of the intermediate transfer belt 6 at the secondary transfer position, there is arranged an opposing roller 21 which forms a counter electrode of the secondary transfer roller 9 and receives a bias. When the toner image on the intermediate transfer belt 6 is transferred onto the transfer material 7, a bias having the same polarity as that of the toner is applied to the opposing roller 21 by a transfer bias application unit 28, and for example, a voltage of from −1,000 V to −3,000 V is applied to cause a current of from −10 μA to −50 μA to flow. The transfer voltage in this case is detected by a transfer high voltage detection unit 29. Further, a cleaning device (belt cleaner) 12 that removes the toner remaining on the intermediate transfer belt 6 after the secondary transfer is provided on a downstream side of the secondary transfer position.

When the transfer material 7 is held and conveyed with a holding and conveyance roller 8 and is introduced into the secondary transfer position, a constant voltage bias (transfer bias) controlled to a predetermined value is applied from the secondary transfer bias application unit 28 to the opposing roller 21 of the secondary transfer roller 9. Through application of the transfer bias having the same polarity as that of the toner to the opposing roller 21, the full-color image (synthesized toner image) of four colors superimposed on the intermediate transfer belt 6 is collectively transferred onto the transfer material 7 in a transfer site, and a full-color unfixed toner image is formed on the transfer material. The transfer material 7 having the toner image transferred thereto is introduced into a fixing device (not shown) in a direction of the arrow H, and the toner image is fixed by heating.

[Methods of measuring Physical Properties]

Next, methods of measuring physical properties according to the present disclosure are described.

<Method of Measuring Surface Roughness with SPM>

A toner is uniformly placed on and fixed to a sample stage using an electroconductive double-sided tape, and a charge of a surface of the toner is removed with a charge eliminating device. After that, the surface of the toner is measured with a scanning probe microscope (SPM). In the SPM measurement, SI-DF20 manufactured by Seiko Instruments Inc. (back surface: Al coat) is used as a cantilever and measurement is performed in a dynamic force mode. The SPM is used after accuracy in a depth direction is observed using a pattern sample for accuracy inspection (100 nm±5 nm) before the measurement. A range of 1 μm×1 μm in a surface of one particle of the toner is subjected to measurement, and the measurement is performed on 50 particles. The obtained SPM images are observed, and at least 30 or more results are analyzed while an image having an obvious defect is removed. The obtained each image is subjected to surface roughness analysis after having been subjected to inclination correction, and a surface roughness Sa of a 1 μm×1 μm surface is calculated. An average value of Sa of all analyzed images was defined as a value of the surface roughness of the toner. In addition, when the measurement result is abnormal owing to contamination or degradation of the cantilever, a maximum protrusion height Sp tends to increase, and hence an image having an Sp serving as the maximum protrusion height of 150 nm or more is removed at the time of the analysis, and is not included in the images for calculating the Sa.

<Method of Observing Partial Structure of Organosilicon Polymer Represented by Formula (R^{a}T3)>

In the present disclosure, a unit of a hydrocarbon group bonded to a silicon atom in a partial structure represented by the following formula (R^{a}T3) was observed by ¹³C-NMR (solid) measurement. Measurement conditions and a sample preparation method are described below:

R^{a}—SiO_{3/2} (R^{a}T3)

where R^{a} represents a hydrocarbon group having 1 to 6 carbon atoms, an aryl group, or a structure represented by the following formula (i) or formula (ii).

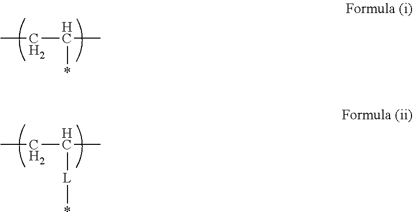

In the formulae (i) and (ii), * represents a bonding site to a Si element in the structure of R^{a}T3, and L in the formula (ii) represents an alkylene group or an arylene group.

“Measurement Conditions of ¹³C-NMR (Solid)”
Apparatus: JNM-ECX500II manufactured by JEOL RESONANCE
Sample tube: 3.2 mmφ
Sample: 150 mg of a tetrahydrofuran-insoluble content of a toner particle for NMR measurement (a preparation method is described below)
Measurement temperature: room temperature
Pulse mode: CP/MAS
Measurement nuclear frequency: 123.25 MHz (¹³C)
Reference substance: adamantane (external standard: 29.5 ppm)
Sample rotation speed: 20 kHz
Contact time: 2 ms
Delay time: 2 s
Number of scans: 1,024 times

“Sample Preparation Method”

Preparation of a measurement sample: 10.0 g of a toner particle is weighed and loaded into a cylindrical paper filter (No. 86R manufactured by Toyo Roshi Kaisha, Ltd.). The resultant is subjected to extraction with a Soxhlet extractor for 20 hours through use of 200 ml of tetrahydrofuran as a solvent. The residue in the cylindrical paper filter is dried in vacuum at 40° C. for several hours, and the resultant is used as a sample for NMR measurement.

In the above-mentioned formula (R^{a}T3), when R^{a} represents the partial structure represented by the above-mentioned formula (i), the presence or absence of the partial structure represented by the above-mentioned formula (R^{a}T3) was observed by the presence or absence of a signal resulting from a methine group (>CH—Si) bonded to a silicon atom.

In the above-mentioned formula (R^{a}T3), when R^{a} represents the partial structure represented by the above-mentioned formula (ii), the presence or absence of a unit represented by the above-mentioned formula (R^{a}T3) was observed by the presence or absence of a signal resulting from, for example, an alkylene group, such as a methylene group (Si—CH₂—) or an ethylene group (Si—C₂H₄—), or an arylene group such as a phenylene group (Si—C₆H₄—), bonded to a silicon atom.

In the above-mentioned formula (R^{a}T3), when R^{a} represents a partial structure represented by the hydrocarbon group having 1 to 6 carbon atoms or the aryl group, the presence or absence of the unit represented by the above-mentioned formula (R^{a}T3) was observed by the presence or absence of a signal resulting from a methyl group (Si—CH₃), an ethyl group (Si—C₂H₅), a propyl group (Si—C₃H₇), a butyl group (Si—C₄H₉), a pentyl group (Si—C₅H₁₁), a hexyl group (Si—C₆H₁₃), or an aryl group such as a phenyl group (Si—C₆H₅—) bonded to a silicon atom.

<Method of Measuring Area of Peak Assigned to Structure of Formula (R^{a}T3) to be measured in ²⁹Si-NMR of Tetrahydrofuran-insoluble Content of Toner>

In the present disclosure, the ²⁹Si-NMR (solid) measurement of the tetrahydrofuran-insoluble content of the toner particle was performed under the measurement conditions described below.

“Measurement Conditions of ²⁹Si-NMR (Solid)”
Apparatus: JNM-ECX500II manufactured by JEOL RESONANCE
Sample tube: 3.2 mmφ
Sample: 150 mg of a tetrahydrofuran-insoluble content of a toner particle for NMR measurement (a preparation method is described below)
Measurement temperature: room temperature
Pulse mode: CP/MAS
Measurement nuclear frequency: 97.38 MHz (²⁹Si)
Reference substance: DSS (external standard: 1.534 ppm)
Sample rotation speed: 10 kHz
Contact time: 10 ms
Delay time: 2 s
Number of scans: 2,000 times to 8,000 times

After the measurement, a plurality of silane components having different substituents and different bonded groups in the tetrahydrofuran-insoluble content of the toner particle were subjected to peak separation into an X1 structure, an X2 structure, an X3 structure, and an X4 structure described below by curve fitting, and the areas of the respective peaks were calculated.

X1 structure: (Ri)(Rj)(Rk)SiO_{1/2} Formula (12)

X2 structure: (Rg)(Rh)Si(O_{1/2})₂ Formula (13)

X3 structure: RmSi(O_{1/2})₃ Formula (14)

X4 structure: Si(O_{1/2})₄ Formula (15)

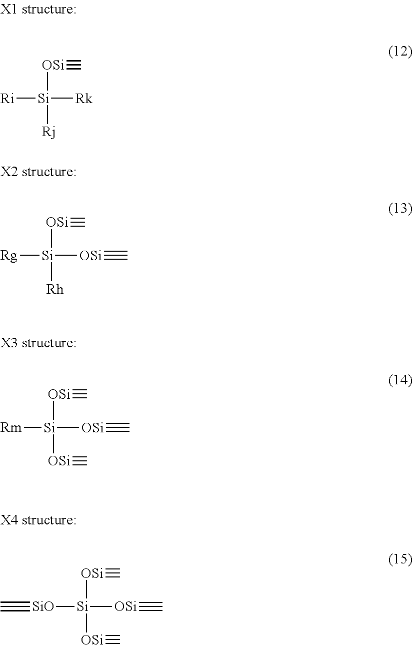

In the formulae (12) to (14), Ri, Rj, Rk, Rg, Rh, and Rm each represent an organic group, a halogen atom, a hydroxy group, or an alkoxy group bonded to a silicon atom.

In the present disclosure, in a chart obtained by the ²⁹Si-NMR measurement of the tetrahydrofuran-insoluble content of the toner particle, a plurality of silane components having different substituents and different bonded groups in the above-mentioned X3 structure were specified by chemical shift values. Those components were subjected to peak separation by curve fitting, and the areas of peaks were determined. Through the above-mentioned method, a ratio of the areas of the peaks assigned to the structure of the formula (R^{a}T3) with respect to a total area of peaks derived from all the silicon elements of the organosilicon polymer was calculated.

When the partial structure represented by the above-mentioned formula (R^{a}T3) needs to be observed in more detail, identification may be performed by the result of ¹H-NMR measurement together with the results of the above-mentioned ¹³C-NMR and ²⁹Si-NMR measurements.

<Method of Measuring Average Circularity of Toner Particle>

The average circularity of the toner particles is measured with a flow-type particle image analyzer “FPIA-3000” (manufactured by Sysmex Corporation) under measurement and analysis conditions at the time of calibration work.

A specific measurement method is as described below. First, about 20 ml of ion-exchanged water having solid impurities and the like removed therefrom in advance is loaded into a container made of glass. About 0.2 ml of a diluted solution prepared by diluting “Contaminon N” (10 mass % aqueous solution of a neutral detergent for washing a precision measuring device formed of a nonionic surfactant, an anionic surfactant, and an organic builder, and having a pH of 7, manufactured by Wako Pure Chemical Industries, Ltd.) with ion-exchanged water by about three mass fold is added as a dispersant to the ion-exchanged water. Further, about 0.02 g of a measurement sample is added to the resultant, and dispersion treatment is performed for 2 minutes with an ultrasonic disperser to provide a dispersion liquid for measurement. In this case, the dispersion liquid is appropriately cooled so that the temperature thereof may reach 10° C. to 40° C. A tabletop ultrasonic cleaner disperser having an oscillation frequency of 50 kHz and an electrical output of 150 W (for example, “VS-150” (manufactured by Velvo-Clear Co.)) is used as the ultrasonic disperser. A predetermined amount of ion-exchanged water is loaded into a water tank, and about 2 ml of the Contaminon N is added to the water tank.

For the measurement, the flow-type particle image analyzer equipped with “LUCPLFLN” (magnification: 20 times, numerical aperture: 0.40) serving as an objective lens is used, and a particle sheath “PSE-900A” (manufactured by Sysmex Corporation) is used as a sheath liquid. The dispersion liquid prepared according to the above-mentioned procedure is introduced into the flow-type particle image analyzer, and the particle diameters of 2,000 toner particles are measured in an HPF measurement mode and a total count mode. Then, a binarization threshold at the time of particle analysis is set to 85%, and a particle diameter to be analyzed is limited to a circle-equivalent diameter of 1.977 μm or more and less than 39.54 followed by the determination of the average circularity of the toner particles.

As for the measurement, automatic focusing adjustment is performed through use of standard latex particles (for example, “RESEARCH AND TEST PARTICLES Latex Microsphere Suspensions 5100A” manufactured by Duke Scientific Corporation is diluted with ion-exchanged water) before the start of the measurement. After that, it is preferred that focus adjustment be performed every two hours from the start of the measurement.

In Examples of the present application, a flow-type particle image analyzer that has been calibrated by Sysmex Corporation and has received an issue of a calibration certificate issued by Sysmex Corporation was used. The measurement was performed under measurement and analysis conditions at the time of the reception of the calibration certificate except that a particle diameter to be analyzed was limited to a circle-equivalent diameter of 1.977 μm or more and less than 39.54 μm.

<Measurement of Weight-Average Particle Diameter (D4) and Number-Average Particle Diameter (D1) of Toner (Particle)>

The weight-average particle diameter (D4) and number-average particle diameter (D1) of the toner (particle) are calculated as described below. A precision particle size distribution-measuring apparatus “Coulter Counter Multisizer 3” (trademark, manufactured by Beckman Coulter, Inc.) based on a pore electrical resistance method with a 100-micrometer aperture tube and dedicated software “Beckman Coulter Multisizer 3 Version 3.51” (manufactured by Beckman Coulter, Inc.) attached thereto for setting measurement conditions and analyzing measured data are used. The measurement is performed at a number of effective measurement channels of 25,000, followed by the analysis of the measured data to calculate the particle diameter.

A solution prepared by dissolving special grade sodium chloride in ion-exchanged water so as to have a concentration of about 1 mass %, for example, “ISOTON II” manufactured by Beckman Coulter, Inc. may be used as an electrolyte aqueous solution to be used in the measurement.

The dedicated software is set as described below prior to the measurement and the analysis.

In the “Change Standard Operating Method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc.) is set as a Kd value. A threshold and a noise level are automatically set by pressing a “Threshold/Measure Noise Level” button. In addition, a current is set to 1,600 μA, a gain is set to 2, and an electrolyte solution is set to ISOTON II, and a check mark is placed in a check box “Flush Aperture Tube after Each Run.”

In the “Convert Pulses to Size Settings Screen” of the dedicated software, a bin spacing is set to a logarithmic particle diameter, the number of particle diameter bins is set to 256, and a particle diameter range is set to 2 μm to 60 μm.

A specific measurement method is as described below.

(1) About 200 ml of the electrolyte aqueous solution is charged into a 250-milliliter round-bottom beaker made of glass dedicated for Multisizer 3. The beaker is set in a sample stand, and the electrolyte aqueous solution in the beaker is stirred with a stirrer rod at 24 rotations/sec in a counterclockwise direction. Then, dirt and bubbles in the aperture tube are removed by the “Flush Aperture” function of the dedicated software.

(2) About 30 ml of the electrolyte aqueous solution is charged into a 100-milliliter flat-bottom beaker made of glass. About 0.3 ml of a diluted solution prepared by diluting “Contaminon N” (10 mass % aqueous solution of a neutral detergent for washing a precision measuring device including a non-ionic surfactant, an anionic surfactant, and an organic builder and having a pH of 7, manufactured by Wako Pure Chemical Industries, Ltd.) with ion-exchanged water by three parts by mass fold is added as a dispersant to the electrolyte aqueous solution.

(3) A predetermined amount of ion-exchanged water and about 2 ml of the Contaminon N are charged into the water tank of an ultrasonic dispersing unit (Ultrasonic Dispersion System Tetora 150, manufactured by Nikkaki Bios Co., Ltd.) in which two oscillators each having an oscillatory frequency of 50 kHz are built so as to be out of phase by 180° and which has an electrical output of 120 W.

(4) The beaker in the section (2) is set in the beaker fixing hole of the ultrasonic dispersing unit, and the ultrasonic dispersing unit is operated. Then, the height position of the beaker is adjusted in order that the liquid surface of the electrolyte aqueous solution in the beaker may resonate with an ultrasonic wave from the ultrasonic dispersing unit to the fullest extent possible.

(5) About 10 mg of the toner (particle) is gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted so as to be 10° C. to 40° C. upon ultrasonic dispersion.

(6) The electrolyte aqueous solution in the section (5) in which the toner (particle) has been dispersed is dropped with a pipette to the round-bottom beaker in the section (1) placed in the sample stand, and the concentration of the toner particle to be measured is adjusted to about 5 mass %. Then, measurement is performed until the particle diameters of 50,000 particles are measured.

(7) The measurement data is analyzed with the dedicated software included with the apparatus, and the weight-average particle diameter (D4) is calculated. The “Average Diameter” on the “Analysis/Volume Statistics (Arithmetic Average)” screen of the dedicated software when the dedicated software is set to show a graph in a vol % unit is the weight-average particle diameter (D4), and the “Average Diameter” on the “Analysis/Number Statistics (Arithmetic Average)” screen of the dedicated software when the dedicated software is set to show a graph in a number % unit is the number-average particle diameter (D1).

<Composition Analysis of Binder Resin>

Method of Separating Binder Resin

100 mg of a toner is dissolved in 3 ml of chloroform. Then, an insoluble content is removed by suction filtration with a syringe having a sample treatment filter (pore size: 0.2 μm to 0.5 μm, for example, Myshoridisk H-25-2 (manufactured by Tosoh Corporation) is used) mounted thereon. A soluble content is introduced into preparative HPLC (device: LC-9130 NEXT preparative column [60 cm], manufactured by Japan Analytical Industry Co., Ltd., exclusion limits: 20,000 and 70,000, two columns connected), and a chloroform eluent is fed. When a peak is observed by the display of a chromatograph to be obtained, a retention time corresponding to a molecular weight of 2,000 or more in a monodisperse polystyrene standard sample is sorted. The obtained fraction solution is dried and solidified to provide a binder resin.

Component Identification of Binder Resin by Nuclear Magnetic Resonance Spectrometry (NMR)

1 mL of deuterated chloroform is added to 20 mg of the binder resin obtained by the above-mentioned method of separating a binder resin, and an NMR spectrum of a proton of the dissolved binder resin is measured. The composition of the resin can be identified from the obtained NMR spectrum. In addition, a molar ratio and a weight ratio of each monomer are calculated, and the content of a unit derived from polyester can be determined. For example, terephthalic acid, bisphenol A, and propylene glycol serving as monomers of the polyester resin have peaks at around 8.0 ppm, around 6.8 ppm, and around 5.5 ppm, respectively, and hence the molar ratio and the weight ratio are calculated based on each of integration ratios of these peaks.
NMR apparatus: ECX500 manufactured by JEOL RESONANCE
Observation nuclear: proton Measurement mode: single pulse Reference peak: TMS

<Measurement of Molecular Weight of Polyester Resin>

Separation and Recovery of Polyester Resin

Separation and recovery of the polyester resin are performed by solvent gradient polymer elution liquid chromatography, which is one kind of liquid chromatography.

100 mg of a toner is dissolved in 3 ml of chloroform. Then, an insoluble content is removed by suction filtration with a syringe having a sample treatment filter (pore size: 0.2 μm to 0.5 μm, for example, Myshoridisk H-25-2 (manufactured by Tosoh Corporation) is used) mounted thereon. A soluble content is introduced into HPLC having the following configuration and conditions, and an eluent is fed with a gradient of solution composition of from 100% acetonitrile to 100% chloroform. An eluate for a retention time of from 3.5 minutes to 9.5 minutes, which is the range in which the polyester resin elutes, is sorted. The obtained fraction solution is dried and solidified to provide a polyester resin.

| Apparatus | Ultimate 3000 (manufactured | |
|---|---|---|
| | by Thermo Fisher Scientific) | |
| Mobile phase | A: chloroform | |
| | B: acetonitrile | |
| Gradient | B 100% (2 min)→25 min→A 100% (10 min) | |
| Flow rate | 1 | mL/min |
| Injection amount | 20 | uL |

| | |
|---|---|
| Column | Tosoh TSKgel ODS (4.6 mmφ ×150 mm × 5 μm) |
| Column temperature | 40° C. |
| Detector | charged aerosol detector (Crona-CAD) |

Measurement of Molecular Weight Distribution (Weight-Average Molecular Weight Mw and Number-Average Molecular Weight Mn)

The molecular weight distribution (weight-average molecular weight Mw and number-average molecular weight Mn) of the polyester resin is measured by gel permeation chromatography (GPC) as described below.

First, a sample is dissolved in tetrahydrofuran (THF) at room temperature over 24 hours. Then, the obtained solution is filtered with a solvent-resistant membrane filter “Myshoridisk” (manufactured by Tosoh Corporation) having a pore diameter of 0.2 μm to provide a sample solution. The sample solution is adjusted so that the concentration of a THF-soluble component become 0.8 mass %. Measurement is performed under the following conditions using the sample solution.
Apparatus: HLC8120GPC (detector: RI) (manufactured by Tosoh Corporation)
   Column: septuple column of Shodex KF-801, 802, 803, 804, 805, 806, and 807 (manufactured by Showa Denko K.K.)
Eluent: tetrahydrofuran (THF)
   Flow rate: 1.0 ml/min
   Oven temperature: 40.0° C.
   Sample injection amount: 0.10 ml

For calculation of the molecular weight of the sample, a molecular weight calibration curve created through use of a standard polystyrene resin (e.g., product name “TSK Standard Polystyrene F-850, F-450, F-288, F-128, F-80, F-40, F-20, F-10, F-4, F-2, F-1, A-5000, A-2500, A-1000, and A-500,” manufactured by Tosoh Corporation) is used.

### EXAMPLES

The present disclosure is more specifically described below by way of Production Examples and Examples. However, the present disclosure is by no means limited by Production Examples and Examples. All the terms “part(s)” in the following blends represent “part(s) by mass”.

<External Additives A to C and E: Production Examples of Silica>

590 g of methanol, 42.0 g of water, and 47.1 g of 28 mass % ammonia water were added to be mixed in a 3 L glass reactor including a stirring machine, a dropping funnel, and a temperature gauge. The obtained solution was adjusted to 35° C., and while the solution was stirred, 1,100.0 g (7.23 mol) of tetramethoxysilane and 395.2 g of 5.4 mass % ammonia water were simultaneously started to be added thereto. Tetramethoxysilane was dropped over 6 hours, and ammonia water was dropped over 5 hours. After the dropping was finished, the resultant was subjected to hydrolysis by further continuing stirring for 0.5 hour, to thereby obtain a methanol-water dispersed liquid of hydrophilic spherical sol-gel silica fine particles. Then, an ester adaptor and a cooling tube were mounted to the glass reactor, and the dispersed liquid was sufficiently dried at 80° C. under reduced pressure. The obtained silica particles were heated at 400° C. for 10 minutes in a thermostat.

The above-mentioned step was performed a plurality of times, and the obtained silica particles were subjected to crushing treatment with a pulverizer (manufactured by Hosokawa Micron Corporation).

Then, a surface treatment step was performed as described below. First, 500 g of the silica particles were loaded into a polytetrafluoroethylene inner cylindrical stainless autoclave having an internal volume of 1,000 mL. Then, the inside of the autoclave was replaced by a nitrogen gas. Then, 3.5 g of hexamethyldisilazane (HMDS) (surface treatment agent) and 1.0 g of water were uniformly sprayed onto the silica particles in an atomized form through a two-fluid nozzle while a stirring blade attached to the autoclave was rotated at 400 rpm. After stirring for 30 minutes, the autoclave was sealed and heated at 200° C. for 2 hours. Subsequently, the system was reduced in pressure while being heated and subjected to deammoniation treatment, to thereby obtain an external additive A.

In addition, external additives B, C, and E were obtained by the same method except that the amount of methanol first used in the production example of the external additive A was changed from 800 g to 900 g, 590 g, and 750 g, respectively.

The obtained external additive is observed with a transmission electron microscope at from 50,000-fold to 80,000-fold magnification, and a constituent element is recognized by EDX analysis, and a long diameter is determined with image processing software. 200 Particles were measured, and a number-average particle diameter was calculated from an average value thereof.

<External Additive D: Production Example of Organosilicon Polymer Particles>

360.0 Parts of water was loaded into a reaction vessel including a temperature gauge and a stirring machine, and 15.0 parts of hydrochloric acid having a concentration of 5.0 mass % was added to the reaction vessel to provide a homogeneous solution. While the solution was stirred at a temperature of 25° C., 136.0 parts of methyltrimethoxysilane was added thereto, and the resultant was stirred for 5 hours and then filtered, to thereby provide a transparent reaction liquid containing a silanol compound or a partial condensate thereof.

440.0 Parts of water was loaded into a reaction vessel including a temperature gauge, a stirring machine, and a dropping device, and 17.0 parts of ammonia water having a concentration of 10.0 mass % was added to the reaction vessel to provide a homogeneous solution. While the solution was stirred at a temperature of 35° C., 100 parts of the reaction liquid obtained in the first step was dropped over 0.5 hour, and the mixture was stirred for 6 hours to provide a suspension. The resultant suspension was subjected to a centrifuge to settle fine particles, and the fine particles were taken out and dried in a dryer at a temperature of 200° C. for 24 hours to provide organosilicon polymer fine particles.

The resultant organosilicon polymer fine particles had a number-average particle diameter of primary particles observed with a transmission scanning electron microscope of 100 nm.

<External Additive F: Method of Producing Strontium Titanate>

Ilmenite ore was dried, pulverized, and treated with concentrated sulfuric acid to be subjected to digestion/extraction. After the unreacted ore was removed, iron sulfate was de-crystallized. A sodium hydroxide aqueous solution was added to the resultant titanyl sulfate to adjust its pH to 9.0, followed by desulfurization. After that, the resultant was neutralized to a pH of 5.8 with hydrochloric acid, and filtered and washed with water. Water was added to the washed cake to form a 1.5 mol/L slurry as TiO₂, and then hydrochloric acid was added to the slurry to adjust its pH to 1.5, and the resultant was deflocculated. The desulfurized and deflocculated metatitanic acid was collected as TiO₂ and loaded into a 3 L reaction vessel. A strontium chloride aqueous solution was added to the deflocculated metatitanic acid slurry so that the molar ratio of SrO/TiO₂ became 1.18, and then the concentration of TiO₂ was adjusted to 0.9 mol/L. Next, the resultant was heated to 90° C. under stirring and mixing. Then, 444 mL of a 10 N sodium hydroxide aqueous solution was added to the resultant over 50 minutes while microbubbling of a nitrogen gas was performed at 600 ml/min. After that, stirring was performed at 95° C. for 1 hour while microbubbling of a nitrogen gas was performed at 400 ml/min. Then, the reaction slurry was rapidly cooled to 12° C. under stirring while cooling water at 10° C. was caused to flow to a jacket of the reaction vessel. The slurry was neutralized by adding hydrochloric acid, and was stirred for 1 hour, followed by filtration and separation.

After firing in a heating furnace, pulverization was performed while the pulverization strength of a pulverizer was adjusted to provide strontium titanate having a number-average particle diameter of 320 nm.

External additives thus produced are summarized in Table 1.

TABLE 1

| | | Number-average |
|---|---|---|
| | | particle diameter |
| | Component | (D1) |
| External additive A | SiO₂ | 30 nm |
| External additive B | SiO₂ | 16 nm |
| External additive C | SiO₂ | 100 nm |
| External additive D | Organosilicon polymer | 100 nm |
| External additive E | SiO₂ | 40 nm |
| External additive F | SrTiO₃ | 320 nm |

### Production Example of Toner Particle A

### (Step of Preparing Aqueous Medium 1)

14.0 Parts of sodium phosphate (dodecahydrate, manufactured by Rasa Industries, Ltd.) was loaded into 1,000.0 parts of ion-exchanged water in a reaction vessel, and the temperature was held at 65° C. for 1.0 hour while the reaction vessel was purged with nitrogen.

Under stirring with T.K. Homomixer (manufactured by Tokushu Kika Kogyo Co., Ltd.) at 12,000 rpm, an aqueous solution of calcium chloride obtained by dissolving 9.2 parts of calcium chloride (dihydrate) in 10.0 parts of ion-exchanged water was collectively loaded to prepare an aqueous medium containing a dispersion stabilizer. Further, 10 mass % hydrochloric acid was loaded into the aqueous medium to adjust its pH to 5.0. Thus, an aqueous medium 1 was obtained.

(Step of Preparing Polymerizable Monomer Composition)

| | |
|---|---|
| Styrene: | 60.0 parts |
| Colorant: | 6.5 parts |
| Color toner | C.I. Pigment Blue 15:3 |
| Black toner | Carbon black |

The materials were loaded into an attritor (manufactured by Mitsui Miike Chemical Engineering Machinery Co., Ltd.), and were dispersed with zirconia particles each having a diameter of 1.7 mm at 220 rpm for 5.0 hours to prepare a pigment-dispersed liquid. The following materials were added to the pigment-dispersed liquid.

| | |
|---|---|
| Styrene: | 20.0 parts |
| n-Butyl acrylate: | 20.0 parts |
| Crosslinking agent (divinylbenzene): | 0.3 part |
| Saturated polyester resin: | 5.0 parts |

(polycondensate of propylene oxide-modified bisphenol A (2-mol adduct)
and terephthalic acid (molar ratio: 10:12), glass transition
temperature Tg = 68° C., weight-average molecular
weight Mw = 10,000, molecular weight distribution Mw/Mn = 5.12)

| | |
|---|---|
| Paraffin wax (HNP9: manufactured by Nippon Seiro Co., Ltd.): | 7.0 parts |

The materials were kept at 65° C., and were uniformly dissolved and dispersed with T.K. Homomixer (manufactured by Tokushu Kika Kogyo Co., Ltd.) at 500 rpm. Thus, a polymerizable monomer composition was prepared.

(Granulation Step)

While the temperature of the aqueous medium 1 was kept at 70° C. and the number of revolutions of T.K. Homomixer was kept at 12,000 rpm, the polymerizable monomer composition was loaded into the aqueous medium 1, and 9.0 parts of t-butyl peroxypivalate serving as a polymerization initiator was added to the mixture. The resultant was granulated as it was with the stirring machine for 10 minutes while the number of revolutions was maintained at 12,000 rpm.

(Polymerization and Distillation Step)

After the granulation step, the stirring machine was changed to a propeller stirring blade, and polymerization was performed for 5.0 hours by holding the temperature of the granulated product at 70° C. while stirring the granulated product at 150 rpm. The temperature was increased to 85° C., and a polymerization reaction was performed by heating the resultant for 2.0 hours.

Then, a reflux tube of the reaction vessel was replaced with a cooling tube, and the slurry was heated to 100° C. to perform distillation for 6 hours. Thus, the unreacted polymerizable monomer was removed to provide a toner particle A-dispersed liquid.

### Production Example of Toner Particle B

A toner particle B-dispersed liquid was obtained in the same manner as in the production example of the toner particle A except that the saturated polyester resin was not added.

### Production Example of Toner Particle C

### [Binder Resin 1]

| | |
|---|---|
| Terephthalic acid | 25.0 mol % |
| Adipic acid | 13.0 mol % |
| Trimellitic acid | 8.0 mol % |
| Bisphenol derivative | 33.0 mol % |
| (2.5-mol propylene oxide adduct) | |
| Bisphenol derivative | 21.0 mol % |
| (2.5-mol ethylene oxide adduct) | |

100 Parts of the total of the above-mentioned acid components and alcohol components, and 0.02 part of tin 2-ethylhexanoate serving as an esterification catalyst were loaded into a four-necked flask. The four-necked flask was mounted with a decompression device, a water-separating device, a nitrogen gas-introducing device, a temperature-measuring device, and a stirring device, and a reaction was performed under a nitrogen atmosphere while the temperature of the mixture was increased to 230° C. After the completion of the reaction, the product was removed from the vessel, and was cooled and pulverized to provide a binder resin 1.

{Binder Resin 2}

A binder resin 2 was produced by the same method as that of the binder resin 1 except that the monomer composition ratio and the reaction temperature were changed as described below.

| | |
|---|---|
| Terephthalic acid | 50.0 mol % |
| Adipic acid | Not used |
| Trimellitic acid | 3.0 mol % |
| Bisphenol derivative | 47.0 mol % |
| (2.5-mol propylene oxide adduct) | |
| Bisphenol derivative | Not used |
| (2.5-mol ethylene oxide adduct) | |
| Reaction temperature: | 190° C. |

{Production of Toner Particle C}

| | |
|---|---|
| Binder resin 1: | 70.0 parts |
| Binder resin 2: | 30.0 parts |
| Colorant: | 65 parts |
| Color toner | C.I. Pigment Blue 15:3 |
| Black toner | Carbon black |
| Paraffin wax (HNP9: manufactured | 2.0 parts |
| by Nippon Seiro Co., Ltd.): | |
| Charge control agent 1 (the | 2.0 parts |
| following structural formula): | |

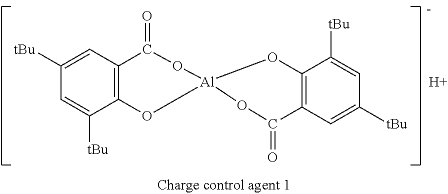

where tBu represents a tert-butyl group.

The above-mentioned materials were premixed with a Henschel mixer, and were then melted and kneaded with a biaxial kneading extruder. At this time, the materials were melted and kneaded while the following setting was performed: the heating temperature of a first kneading portion near the supply port of the extruder was set to 110° C.; the heating temperature of a second kneading portion was set to 130° C.; the heating temperature of a third kneading portion was set to 150° C.; and the number of revolutions of a paddle was set to 200 rpm. The resultant kneaded product was cooled and coarsely pulverized with a hammer mill, and was then pulverized with a fine pulverizer using a jet stream. The resultant finely pulverized powder was classified with a multidivision classifier utilizing the Coanda effect to provide toner particles C having a weight-average particle diameter of 6.6 μm.

In addition, when the organosilicon polymer surface layer is arranged, 35 parts of the resultant toner particle C was loaded into the aqueous medium 1 described in the production example of the toner particle A to provide a toner particle C-dispersed liquid.

<Method of Producing Toner Particle D>

A toner particle D-dispersed liquid was obtained in the same manner as in the toner particle C except that, in the method of producing the toner particle C, the compositions of binder resins 1 and 2 were changed to the compositions described below.
Binder resin 1: 80 parts of styrene and 20 parts of butyl acrylate (number-average molecular weight Mn: 18,000)
Binder resin 2: 70 parts of styrene and 30 parts of butyl acrylate (number-average molecular weight Mn: 5,200)

<When Organosilicon Polymer Surface Layer is Present>

### (Polymerization of Organosilicon Compound)

60.0 Parts of ion-exchanged water was weighed in a reaction vessel including a stirring machine and a temperature gauge, and its pH was adjusted to 4.0 with 10 mass % hydrochloric acid. The resultant was heated while being stirred so that its temperature reached 40° C. After that, 40.0 parts of methyltriethoxysilane serving as an organosilicon compound was added to the resultant, and the mixture was stirred for 2 hours or more so that methyltriethoxysilane was hydrolyzed. When it was visually observed that oil and water did not separate from each other but formed one layer, the hydrolysis was regarded as having reached its endpoint. The resultant was cooled to provide a hydrolyzed liquid of the organosilicon compound.

After the above-mentioned resultant toner particle-dispersed liquid was cooled to 55° C., 25.0 parts of the hydrolyzed liquid of the organosilicon compound was added to start polymerization of the organosilicon compound. After the mixture was held as it was for 15 minutes, the pH was adjusted to 5.5 with a 3.0% sodium hydrogen carbonate aqueous solution. While stirring was continued at 55° C., the resultant was held for 60 minutes, and after that, the pH was adjusted to 9.5 with a 3.0% sodium hydrogen carbonate aqueous solution, and the resultant was further held for 240 minutes to provide a toner particle-dispersed liquid with an organosilicon polymer surface layer. A protrusion height, in other words, the surface roughness, may be adjusted by the addition amount of the hydrolyzed liquid of the organosilicon compound. In this Example, in which 25.0 parts the hydrolyzed liquid of the organosilicon compound is added, the surface roughness is 18 nm.

<When Organosilicon Polymer Surface Layer is Absent>

The above-mentioned toner particle-dispersed liquid is proceeded to a washing and drying step as it is.

(Washing and Drying Step)

After the completion of the polymerization step, the slurry of the toner particle was cooled, and hydrochloric acid was added to the slurry of the toner particle to adjust its pH to 1.5 or less. The mixture was stirred and left to stand for 1 hour, and was then subjected to solid-liquid separation with a pressure filter to provide a toner cake. The cake was reslurried with ion-exchanged water to provide a dispersed liquid again, and then the liquid was subjected to solid-liquid separation with the above-mentioned filter. The reslurrying and the solid-liquid separation were repeated until the electrical conductivity of the filtrate became 5.0 μS/cm or less. After that, the resultant was finally subjected to solid-liquid separation to provide a toner cake.

The resultant toner cake was dried with a flash dryer FLASH JET DRYER (manufactured by Seishin Enterprise Co., Ltd.), and fine powder and coarse powder were further discarded with a multidivision classifier utilizing the Coanda effect. Thus, a toner particle was obtained. Conditions for the drying were as follows: a blowing temperature was 90° C., a dryer outlet temperature was 40° C., and the rate at which the toner cake was supplied was adjusted in accordance with the water content of the toner cake to such a rate that the outlet temperature did not deviate from 40° C.

The resultant toner particles are shown in Table 2.

TABLE 2

| | | | | | Organosilicon | Particle | |
|---|---|---|---|---|---|---|---|
| | | | | | polymer | diameter | |
| | Production | Binder | | Releasing | surface | D4 | Average |
| | method | resin | Resin 2 | agent | layer | (μm) | circularity |
| Toner | Suspension | Styrene | Polyester | HNP9 | Present | 7.0 | 0.973 |
| particle A1 | polymerization | acryl | | | | | |
| Toner | Suspension | Styrene | Polyester | HNP9 | Absent | 7.0 | 0.973 |
| particle A2 | polymerization | acryl | | | | | |
| Toner | Suspension | Styrene | None | HNP9 | Present | 7.2 | 0.967 |
| particle B1 | polymerization | acryl | | | | | |
| Toner | Suspension | Styrene | None | HNP9 | Absent | 7.2 | 0.967 |
| particle B2 | polymerization | acryl | | | | | |
| Toner | Pulverization | Polyester | None | HNP9 | Present | 6.8 | 0.936 |
| particle C1 | | | | | | | |
| Toner | Pulverization | Polyester | None | HNP9 | Absent | 6.8 | 0.936 |
| particle C2 | | | | | | | |
| Toner | Pulverization | Styrene | None | HNP9 | Present | 6.8 | 0.941 |
| particle D1 | | acryl | | | | | |
| Toner | Pulverization | Styrene | None | HNP9 | Absent | 6.8 | 0.941 |
| particle D2 | | acryl | | | | | |

### Example 1

### Production Example of Toner Set 1

In the combination shown in Table 3, a color toner is obtained by adding an organosilicon polymer surface layer and externally adding the external additive A to the toner particle A, and a black toner is obtained by externally adding the external additive A and the external additive B to the toner particle A without an organosilicon polymer surface layer. As a method for the external addition, with respect to 100 parts of the toner particle, the external additive having a number of parts shown in Table 3 was loaded into SUPERMIXER PICCOLO SMP-2 (manufactured by Kawata Mfg. Co., Ltd.), and was mixed at 3,000 rpm for 20 minutes. After that, the mixture was sieved with a mesh having an aperture of 150 μm to provide a toner set 1. Physical property evaluation and the following durability evaluation were performed on the resultant toner set 1. The evaluation results are shown in Table 4.

### Example 2 to 12 and Comparative Examples 1 to 6

### Production Examples of Toner Sets 2 to 18

Toner sets 2 to 18 are produced in the same manner as in the production example of the toner set 1 except that the combination and formulation shown in Table 3 are used. Physical property evaluation and the following durability evaluation were performed on the resultant toner sets 2 to 18. The evaluation results are shown in Table 4. The color toner of Example 11 is an example in which, while an organosilicon polymer surface layer is not formed in the toner particle production process, the toner has an organosilicon polymer on a surface of the toner particle through external addition of an organosilicon polymer particle (external additive D).

TABLE 3

| | | Color toner | | | | Black toner | | | |
|---|---|---|---|---|---|---|---|---|---|
| | | | Organo- | | | | Organo- | | |
| | | | silicon | | | | silicon | | |
| | | | polymer | | | | polymer | | |
| | | Toner | surface | External | External | Toner | surface | External | External |
| | | particle | layer | additive 1 | additive 2 | particle | layer | additive 1 | additive 2 |
| Example 1 | Toner | Toner | Present | External | — | Toner | Absent | External | External |
| | set 1 | particle | | additive A | | particle | | additive A | additive B |
| | | A | | (0.5) | | A | | (0.5) | (2.0) |
| Example 2 | Toner | Toner | Present | External | — | Toner | Absent | External | External |
| | set 2 | particle | | additive A | | particle | | additive A | additive B |
| | | B | | (0.5) | | B | | (0.5) | (2.0) |
| Example 3 | Toner | Toner | Present | External | — | Toner | Absent | External | External |
| | set 3 | particle | | additive A | | particle | | additive B | additive C |
| | | B | | (0.5) | | B | | (2.0) | (0.8) |
| Example 4 | Toner | Toner | Present | External | — | Toner | Absent | External | External |
| | set 4 | particle | | additive A | | particle | | additive A | additive B |
| | | B | | (0.5) | | B | | (0.5) | (2.0) |
| Example 5 | Toner | Toner | Present | External | — | Toner | Absent | External | External |
| | set 5 | particle | | additive A | | particle | | additive A | additive B |
| | | B | | (0.5) | | B | | (0.5) | (2.0) |
| Example 6 | Toner | Toner | Present | External | — | Toner | Absent | External | External |
| | set 6 | particle | | additive A | | particle | | additive A | additive B |
| | | C | | (0.5) | | C | | (0.5) | (2.0) |
| Example 7 | Toner | Toner | Present | External | — | Toner | Absent | External | External |
| | set 7 | particle | | additive A | | particle | | additive A | additive B |
| | | D | | (0.5) | | D | | (0.5) | (2.0) |
| Example 8 | Toner | Toner | Present | External | — | Toner | Present | External | — |
| | set 8 | particle | | additive A | | particle | | additive A | |
| | | D | | (0.5) | | D | | (0.5) | |
| Example 9 | Toner | Toner | Present | External | — | Toner | Absent | External | External |
| | set 9 | particle | | additive A | | particle | | additive B | additive C |
| | | D | | (0.5) | | D | | (2.0) | (1.6) |
| Example 10 | Toner | Toner | Present | External | — | Toner | Absent | External | External |
| | set 10 | particle | | additive A | | particle | | additive B | additive C |
| | | D | | (0.5) | | D | | (2.0) | (1.6) |
| Example 11 | Toner | Toner | Absent | External | External | Toner | Absent | External | External |
| | set 11 | particle | | additive A | additive D | particle | | additive B | additive C |
| | | D | | (0.5) | (3.8) | D | | (2.0) | (1.6) |
| Example 12 | Toner | Toner | Absent | External | External | Toner | Absent | External | External |
| | set 12 | particle | | additive A | additive C | particle | | additive B | additive C |
| | | D | | (0.5) | (3.8) | D | | (2.0) | (1.6) |
| Comparative | Toner | Toner | Present | External | — | Toner | Present | External | — |
| Example 1 | set 13 | particle | | additive A | | particle | | additive A | |
| | | A | | (0.5) | | A | | (0.5) | |
| Comparative | Toner | Toner | Absent | External | External | Toner | Absent | External | External |
| Example 2 | set 14 | particle | | additive B | additive E | particle | | additive B | additive E |
| | | A | | (1.0) | (0.9) | A | | (0.3) | (0.1) |
| Comparative | Toner | Toner | Present | External | — | Toner | Absent | External | External |
| Example 3 | set 15 | particle | | additive A | | particle | | additive A | additive B |
| | | A | | (0.5) | | A | | (0.5) | (2.0) |
| Comparative | Toner | Toner | Present | External | — | Toner | Absent | External | — |
| Example 4 | set 16 | particle | | additive A | | particle | | additive B | |
| | | A | | (0.5) | | A | | (0.1) | |
| Comparative | Toner | Toner | Absent | External | External | Toner | Absent | External | External |
| Example 5 | set 17 | particle | | additive B | additive E | particle | | additive B | additive E |
| | | A | | (1.0) | (0.3) | A | | (0.3) | (0.1) |
| Comparative | Toner | Toner | Absent | External | External | Toner | Absent | External | — |
| Example 6 | set 18 | particle | | additive B | additive F | particle | | additive B | |
| | | A | | (1.0) | (0.3) | A | | (1.0) | |

Addition numbers of parts are shown in the parentheses in the table.

TABLE 4

| | | | | | Image evaluation | | |
|---|---|---|---|---|---|---|---|
| | | | | | | | C/Bk |
| | | | | | | | boundary |
| | | Surface | | | | | sharpness |
| | | roughness Sa | | | C/Bk | Black | after printing |
| | | | | Sa(C)/ | boundary | image | on 4,000 |
| | | Sa(C) | Sa(Bk) | Sa(Bk) | sharpness | unevenness | sheets |
| Example 1 | Toner set 1 | 18 | 8 | 2.25 | A | A | A |
| Example 2 | Toner set 2 | 18 | 8 | 2.25 | A | A | B |
| Example 3 | Toner set 3 | 18 | 12 | 1.50 | A | A | B |
| Example 4 | Toner set 4 | 26 | 8 | 3.25 | B | A | B |
| Example 5 | Toner set 5 | 26 | 8 | 3.25 | B | A | C |
| Example 6 | Toner set 6 | 26 | 8 | 3.25 | B | B | B |
| Example 7 | Toner set 7 | 26 | 8 | 3.25 | B | B | C |
| Example 8 | Toner set 8 | 26 | 16 | 1.63 | B | C | C |
| Example 9 | Toner set 9 | 26 | 16 | 1.63 | B | C | C |
| Example 10 | Toner set | 26 | 16 | 1.63 | B | C | C |
| | 10 | | | | | | |
| Example 11 | Toner set | 26 | 16 | 1.63 | B | C | C |
| | 11 | | | | | | |
| Example 12 | Toner set | 26 | 16 | 1.63 | B | C | D |
| | 12 | | | | | | |
| Comparative | Toner set | 16 | 16 | 1.00 | E | E | E |
| Example 1 | 13 | | | | | | |
| Comparative | Toner set | 9 | 6 | 1.50 | C | C | E |
| Example 2 | 14 | | | | | | |
| Comparative | Toner set | 31 | 8 | 3.88 | A | A | E |
| Example 3 | 15 | | | | | | |
| Comparative | Toner set | 18 | 4 | 4.50 | E | E | E |
| Example 4 | 16 | | | | | | |
| Comparative | Toner set | 7 | 6 | 1.22 | C | C | E |
| Example 5 | 17 | | | | | | |
| Comparative | Toner set | 7 | 7 | 1.01 | E | E | E |
| Example 6 | 18 | | | | | | |

<Image Evaluation Method with Laser Beam Printer>

A reconstructed machine of a commercial laser beam printer LBP-7700C manufactured by Canon Inc. was used. A reconstructed point was as follows: the main body of the evaluation machine and the software were changed so that a rotation speed of a developing roller become 360 mm/sec. Further, reconstruction was performed so that output with two CRGs of black and cyan was enabled. The toner sets of Table 4 were filled into a cartridge in combination thereof, and the resultant was mounted to a cyan station and a black station of the above-mentioned printer, to thereby perform an image output test. LETTER size XEROX 4200 PAPER (manufactured by XEROX Corporation, 75 g/m²) was used as paper.

(C/Bk Boundary Sharpness)

Under a low-temperature and low-humidity environment (temperature: 15.0° C., humidity: 10% RH), an image in which solid images of a half cyan image and a half black image adjacent to each other is output on one surface of LETTER sized paper.

A boundary portion in which the cyan and black images are adjacent to each other was observed with an optical microscope at 300-fold magnification, and the clearness of the boundary was ranked. A larger width of the portion in which toners of two colors are mixed, that is, a larger amount of scattering of the toner, causes an unclear boundary.
Rank A: width of the boundary or scattering of black toner to cyan side is within 100 μm
Rank B: width of the boundary or scattering of black toner to cyan side is within 200 μm
Rank C: width of the boundary or scattering of black toner to cyan side is within 300 μm
Rank D: width of the boundary or scattering of black toner to cyan side is more than 300 μm

(Bk Image Unevenness)

In the same manner as in the above-mentioned C/Bk boundary sharpness evaluation, an image in which a halftone image is output instead of the solid image is used for the evaluation.

The unevenness of the black image is visually evaluated. The unevenness of the black image is comparatively conspicuous because the cyan halftone image is relatively uniform. Optical illusion is a phenomenon which further deteriorates the unevenness, and hence evaluation with the human eye is most suitable. The unevenness was ranked with an average of five panelists.
Rank A: no unevenness is observed on black image and black image is uniform
Rank B: unclear but slight unevenness is observed on black image
Rank C: slight unevenness is present on black image
Rank D: clear unevenness is observed on black image

(C/Bk Boundary Sharpness after Printing on 4,000 Sheets)

50 g each of cyan and black were filled into a CRG, and images each having a print percentage of 1% were output on 4,000 sheets under a low-temperature and low-humidity environment (temperature: 15.0° C., humidity: 10% RH). After that, the above-mentioned C/Bk boundary sharpness evaluation was performed. LETTER size XEROX 4200 PAPER (manufactured by XEROX Corporation, 75 g/m²) was used as paper for endurance in the same manner as the paper for evaluation.
Rank A: width of the boundary or scattering of black toner to cyan side is within 100 μm
Rank B: width of the boundary or scattering of black toner to cyan side is within 200 μm
Rank C: width of the boundary or scattering of black toner to cyan side is within 300 μm
Rank D: width of the boundary or scattering of black toner to cyan side is more than 300 μm

According to the present disclosure, the toner set, the image forming apparatus, and the image forming method each of which is capable of eliminating unclearness in a color boundary of an image in which a color image and a black image are printed side by side, and reducing an emphasized image unevenness of the black image can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-028819, filed Feb. 28, 2022, which is hereby incorporated by reference herein in its entirety.

What is claimed is:

1. A toner set comprising:
a black toner for forming a black image; and
a color toner for forming a color toner image,
wherein the black toner is a toner comprising a black toner particle containing a black colorant formed of carbon black or iron oxide, a binder resin, and a releasing agent, and an external additive,
wherein the color toner is a toner comprising a color toner particle containing a color organic colorant, a binder resin, and a releasing agent,
wherein a ratio in surface roughness (Sa) between the toners is 1.30≤ surface roughness Sa(C) of color toner/surface roughness Sa(Bk) of black toner ≤4.00, and
wherein the surface roughness Sa(C) of the color toner is 10 nm to 30 nm.

2. The toner set according to claim 1, wherein the surface roughness Sa(Bk) of the black toner is 5 nm or more and less than 15 nm.

3. The toner set according to claim 1, wherein the color toner further comprises an organosilicon polymer on a surface of the color toner particle.

4. The toner set according to claim 1, wherein the black toner particle and the color toner particle have an average circularity within a range of 0.950 to 1.000.

5. The toner set according to claim 3, wherein, in ²⁹Si-NMR measurement of the organosilicon polymer of the color toner, a ratio of an area of a peak derived from silicon having a T3 unit structure to a total area of peaks derived from all silicon elements contained in the organosilicon polymer is 0.50 to 1.00.

6. The toner set according to claim 1, wherein the surface roughness Sa(C) of the color toner falls within a range of 15 nm to 25 nm, and wherein the surface roughness Sa (Bk) of the black toner falls within a range of 5 nm to 10 nm.

7. The toner set according to claim 1, wherein the color toner particle comprises a polyester resin having a molecular weight of 5,000 to 30,000 present on a surface thereof.

8. An image forming apparatus comprising:
a first image forming station;
a second image forming station;
an intermediate transfer body;
a secondary transfer unit configured to secondarily transfer a synthesized toner image from a surface of the intermediate transfer body onto a surface of a transfer material, and
a fixing unit configured to fix the synthesized toner image to the surface of the transfer material,
the first image forming station comprising:
a first electrophotographic photosensitive member;
a charging device configured to charge a surface of the first electrophotographic photosensitive member;
an image exposing device configured to irradiate the surface of the first electrophotographic photosensitive member with image exposure light to form a first electrostatic image;
a developing device which comprises a black toner and is configured to develop the first electrostatic image by the black toner to form a black toner image on the surface of the first electrophotographic photosensitive member; and
a primary transferring device configured to primarily transfer the black toner image from the surface of the first electrophotographic photosensitive member onto the surface of the intermediate transfer body,
the second image forming station comprising:
a second electrophotographic photosensitive member;
a charging device configured to charge a surface of the second electrophotographic photosensitive member;
an image exposing device configured to irradiate the surface of the second electrophotographic photosensitive member with image exposure light to form a second electrostatic image;
a developing device which comprises a color toner and is configured to develop the second electrostatic image by the color toner to form a color toner image on the surface of the second electrophotographic photosensitive member; and
a primary transferring device configured to primarily transfer the color toner image from the surface of the second electrophotographic photosensitive member onto the surface of the intermediate transfer body,
wherein the synthesized toner image is formed by the primary transfer of the black toner image and the color toner image onto the surface of the intermediate transfer body,
wherein the black toner is a toner comprising a black toner particle containing a black colorant formed of carbon black or iron oxide, a binder resin, and a releasing agent, and an external additive,
wherein the color toner is a toner comprising a color toner particle containing a color organic colorant, a binder resin, and a releasing agent,
wherein a ratio in surface roughness (Sa) between the toners is 1.30≤ surface roughness Sa(C) of color toner/surface roughness Sa(Bk) of black toner ≤4.00, and
wherein the surface roughness Sa(C) of the color toner is 10 nm to 30 nm.

9. An image forming method comprising:
a first image forming step;
a second image forming step;
a secondary transfer step of secondarily transferring a synthesized toner image from a surface of an intermediate transfer body onto a surface of a transfer material, and
a fixing step of fixing the synthesized toner image to the surface of the transfer material,
the first image forming step comprising:
a charging step of charging a surface of a first electrophotographic photosensitive member;
an image exposing step of irradiating the surface of the first electrophotographic photosensitive member with image exposure light to form a first electrostatic image;
a developing step of developing the first electrostatic image by a black toner to form a black toner image on the surface of the first electrophotographic photosensitive member; and
a primary transfer step of primarily transferring the black toner image from the surface of the first electrophotographic photosensitive member onto the surface of the intermediate transfer body,
the second image forming step comprising:
a charging step of charging a surface of a second electrophotographic photosensitive member;
an image exposing step of irradiating the surface of the second electrophotographic photosensitive member with image exposure light to form a second electrostatic image;
a developing step of developing the second electrostatic image by a color toner to form a color toner image on the surface of the second electrophotographic photosensitive member; and
a primary transfer step of primarily transferring the color toner image from the surface of the second electrophotographic photosensitive member onto the surface of the intermediate transfer body,
wherein the synthesized toner image is formed by the primary transfer of the black toner image and the color toner image onto the surface of the intermediate transfer body,
wherein the black toner is a toner comprising a black toner particle containing a black colorant formed of carbon black or iron oxide, a binder resin, and a releasing agent, and an external additive,
wherein the color toner is a toner comprising a color toner particle containing a color organic colorant, a binder resin, and a releasing agent,
wherein a ratio in surface roughness (Sa) between the toners is 1.30≤ surface roughness Sa(C) of color toner/surface roughness Sa(Bk) of black toner ≤4.00, and
wherein the surface roughness Sa(C) of the color toner is 10 nm to 30 nm.
